(19) United States
(12) Patent Application Publication
(10) Pub. No.: US 2026/0112356 A1
(43) Pub. Date: Apr. 23, 2026

(54) METHOD FOR TRAINING SPEECH SYNTHESIS MODEL, SPEECH SYNTHESIS METHOD, AND ELECTRONIC DEVICE

(71) Applicant: BAIDU INTERNATIONAL TECHNOLOGY (SHENZHEN) CO., LTD., Guangdong (CN)

(72) Inventors: Xiaolong Lin, Guangdong (CN); Yiqiao Huang, Guangdong (CN)

(73) Assignee: BAIDU INTERNATIONAL TECHNOLOGY (SHENZHEN) CO., LTD., Guangdong (CN)

(21) Appl. No.: 19/425,609

(22) Filed: Dec. 18, 2025

(30) Foreign Application Priority Data
Nov. 13, 2025 (CN) 202511663645.8

(51) Int. Cl. G10L 13/047; G06F 40/30; G10L 25/30

(52) U.S. Cl. CPC G10L 13/047; G06F 40/30; G10L 25/30

(57) ABSTRACT

A method for training a speech synthesis model includes obtaining training data; obtaining an initial speech synthesis model; training a semantic encoding network and a semantic decoding network in the speech synthesis model respectively based on a style sample speech, a timbre sample speech, an input sample text, and an output sample speech in training samples of the training data, to obtain a trained speech synthesis model.

### CROSS-REFERENCE TO RELATED APPLICATIONS

The application is based on and claims the priority of Chinese patent application No. 202511663645.8 filed on Nov. 13, 2025, the entire content of which is incorporated herein by reference.

### TECHNICAL FIELD

This disclosure relates to the field of artificial intelligence technology, and in particular to deep learning, natural language processing, speech technology, large models, and other technical fields, and in particular to a method for training a speech synthesis model, a speech synthesis method, a device, and an electronic device.

### BACKGROUND

A model structure of a current speech synthesis model consists of a backbone network and a style control module. An input of the style control module is a style label or a style prompt text. An expression form of the style label or of the style prompt text is single.

### SUMMARY

According to an aspect of the disclosure, a method for training a speech synthesis model is provided. The method includes: obtaining training data; in which training samples in the training data include a style sample speech, a timbre sample speech, an input sample text, and an output sample speech; obtaining an initial speech synthesis model; in which the speech synthesis model includes a semantic encoding network and a semantic decoding network; training the semantic encoding network and the semantic decoding network respectively based on the style sample speech, the timbre sample speech, the input sample text, and the output sample speech, to obtain a trained semantic encoding network and a trained semantic decoding network; and obtaining a trained speech synthesis model based on the trained semantic encoding network and the trained semantic decoding network.

According to another aspect of the disclosure, a speech synthesis method is provided. The method includes: obtaining a style speech, a timbre speech, and an input text to be processed; obtaining a speech synthesis model; in which a semantic encoding network and a semantic decoding network in the speech synthesis model are trained respectively based on a style sample speech, a timbre sample speech, an input sample text, and an output sample speech; inputting the style speech, the timbre speech, and the input text into the semantic encoding network of the speech synthesis model, to obtain a semantic feature vector sequence outputted by the semantic encoding network; inputting the semantic feature vector sequence into the semantic decoding network to obtain an output speech corresponding to the input text outputted by the semantic decoding network.

According to another aspect of the disclosure, there is provided an electronic device. The electronic device includes: at least one processor; and a memory connected in communication with at least one processor; in which the memory has instructions executable by at least one processor stored thereon, and the instructions are executed by the at least one processor to enable the at least one processor to: obtain training data; in which training samples in the training data include a style sample speech, a timbre sample speech, an input sample text, and an output sample speech; obtain an initial speech synthesis model; in which the speech synthesis model includes a semantic encoding network and a semantic decoding network; train the semantic encoding network and the semantic decoding network respectively based on the style sample speech, the timbre sample speech, the input sample text, and the output sample speech, to obtain a trained semantic encoding network and a trained semantic decoding network; and obtain a trained speech synthesis model based on the trained semantic encoding network and the trained semantic decoding network.

### BRIEF DESCRIPTION OF THE DRAWINGS

The accompanying drawings are intended for a better understanding of this solution and do not constitute a limitation on this disclosure.

FIG. 1 is a schematic diagram according to a first embodiment of the disclosure.

FIG. 2 is a schematic diagram according to a second embodiment of the disclosure.

FIG. 3 is a schematic diagram according to a third embodiment of the disclosure.

FIG. 4 is a schematic diagram according to a fourth embodiment of the disclosure.

FIG. 5 is a schematic diagram illustrating a framework of a speech synthesis model.

FIG. 6 is a schematic diagram according to a fifth embodiment of the disclosure.

FIG. 7 is a schematic diagram according to a sixth embodiment of the disclosure.

FIG. 8 is a block diagram illustrating an electronic device for implementing the method for training the speech synthesis model or the speech synthesis method according to embodiments of the disclosure.

### DETAILED DESCRIPTION

The following is a description of exemplary embodiments of the disclosure, including various details of embodiments of the disclosure to aid understanding, which should be considered merely illustrative. Therefore, those skilled in the art should recognize that various changes and modifications may be made to embodiments of the disclosure without departing from the scope and spirit of the disclosure. Similarly, for clarity and conciseness, descriptions of well-known functions and structures have been omitted in following description.

A current speech synthesis model consists of a backbone network and a style control module. An input of the style control module is a style label or a style prompt text. The style label or the style prompt text has single expression form. During the model training process, it needs to train and process each style label or each tyle prompt text separately, which is costly and leads to poor generalization of a trained speech synthesis model on new style labels or new style prompt texts.

In view of the above problem, the disclosure provides a method for training a speech synthesis model, a speech synthesis method, a device, and an electronic device.

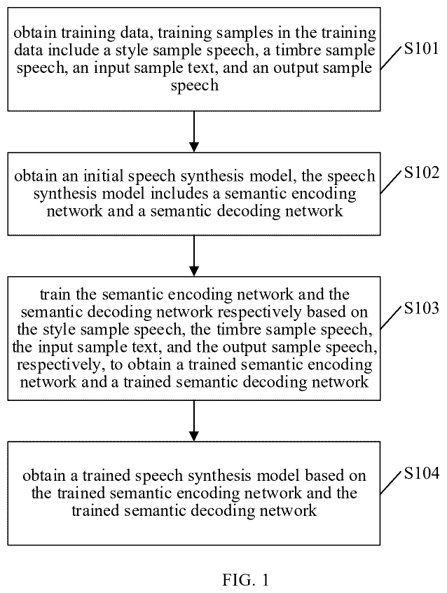

FIG. 1 is a schematic diagram according to a first embodiment of the disclosure. It should be noted that the method for training the speech synthesis model according to the disclosure may be performed by a device for training the speech synthesis model. The device may be provided in an electronic device to enable the electronic device to perform the training function of the speech synthesis model.

The electronic device may be any device with computing power, such as personal computers (PCs), mobile terminals, servers, or the like. The mobile terminal may be a hardware device with various operating systems, touch screens, and/or display screens, such as a vehicle-mounted device, a mobile phone, a tablet, a personal digital assistant, a wearable device, a smart speaker, a server, a server cluster, or the like.

The device for training the speech synthesis model may also be software in an electronic device, such as training software of a speech synthesis model. In following embodiments, the execution subject is an electronic device as an example for explanation.

As illustrated in FIG. 1, the method for training the speech synthesis model may include the following.

At step 101, training data is obtained. Training samples in the training data include a style sample speech, a timbre sample speech, an input sample text, and an output sample speech.

In embodiments of the disclosure, in an example, the process of executing step 101 on the electronic device may be, for example, obtaining the style sample speech, the timbre sample speech, and the input sample text; obtaining a reference style speech and a reference timbre speech; where a style of the reference style speech is the same as a style of the style sample speech, a timber of the reference timber speech is the same tone as a timber of the timber sample speech, and a text corresponding to the reference timber speech is the input sample text; and generating an output sample speech based on the reference style speech and the reference timbre speech.

A process of obtaining the reference style speech may be, for example, determining a style description text corresponding to the style sample speech; and selecting a speech from multiple speeches with the style described in the style description text as a reference style speech. A filtering condition is that a text obtained by performing speech recognition on the selected speech has different contents from the text obtained by performing speech recognition on the style sample speech.

A process of obtaining the reference timber speech may be, for example, determining timber information corresponding to the reference timber speech; and selecting a candidate speech from multiple speeches with this timbre information as the reference timbre speech. The filtering condition is that a text obtained by performing the speech recognition on the selected speech has the same content as the input sample text.

A process that the electronic device generates the output sample speech based on the reference style speech and the reference timbre speech may be, for example, inputting the reference style speech and the reference timbre speech into a speech fusion model to obtain the output sample speech generated by the speech fusion model. The speech fusion model may be, for example, the Voice Conversion model (VC) or others.

Combining the reference style speech and the reference timber speech to generate the output sample speech may reduce the cost of preparing the training samples and improve the efficiency of preparing the training samples.

In embodiments of the disclosure, in order to further reduce the cost of preparing the training samples, the electronic device may query the style speech database based on the style description sample text to obtain matched style sample speech. Correspondingly, a process that the electronic device obtains the style sample speech, the timbre sample speech, and the input sample text may be, for example, obtaining style description sample text, the timbre sample speech, and the input sample text; obtaining the style speech database, in which style speech database includes at least one style description text and a respective style speech corresponding to each style description text; retrieving the first style description sample that matches the style description sample text from the style speech database by querying the style speech database; and determining the style speech corresponding to the first style description sample as the style sample speech.

The matching between the style description sample text and the first style description sample may be at least one of the following: the style description sample text is the same as the first style description sample; a similarity between the style description sample text and the first style description sample is greater than or equal to a similarity threshold; a similarity between the style described by the style description sample text and the style described by the first style description sample is greater than or equal to a similarity threshold.

The style may be, for example, easy and humor without losing organization, comforting warmly like friends, or the like. Taking the style as easy and humorous without losing organization as an example, the corresponding style description sample text may be “said in an easy and humorous without losing organization tone”. Taking comforting warmly like a friend as an example, the corresponding style description sample text may be “said in a comforting warmly like a friend tone”.

In another example, a process of executing step 101 on the electronic device may, for example, obtaining style sample speech, timbre sample speech, and input sample text; based on the style sample speech, the timbre sample speech, and the input sample text, selecting a speech from a large number of candidate speeches as the output sample speech. Ae filtering condition is that a text corresponding to the selected speech is the input sample text, the speech has the same style as the style sample speech, and the timbre of the speech is the same as the timbre of the timbre sample speech.

At step 102, the initial speech synthesis model is obtained. The speech synthesis model includes a semantic encoding network and a semantic decoding network.

In embodiments of the disclosure, the semantic encoding network is configured to extract a semantic feature vector sequence based on the style sample speech, the timbre sample speech, and the input sample text, to obtain a predicted semantic feature vector sequence; and the semantic decoding network is configured to perform semantic decoding processing on the predicted semantic feature vector sequence to obtain an outputted predicted speech.

At step 103, the semantic encoding network and the semantic decoding network are trained based on the style sample speech, the timbre sample speech, the input sample text, and the output sample speech, respectively, to obtain the trained semantic encoding network and the trained semantic decoding network.

In embodiments of the disclosure, a process of executing step 103 on the electronic device may be, for example, training the semantic encoding network based on the style sample speech, the timbre sample speech, the input sample text, and the output sample speech to obtain the trained semantic encoding network; training the semantic decoding network based on the style sample speech, the timbre sample speech, the input sample text, the output sample speech, and the trained semantic encoding network, to obtain the trained semantic decoding network.

The settings of style sample speech and the timbre sample speech enable the semantic encoding network to combine the style sample speech and the timbre sample speech for the extraction and fusion of style and timbre features and be used for semantic feature extraction processing. Therefore, the trained semantic encoding network may combine the extracted speeches for the extraction and fusion of style and/or timbre features for new styles and/or timbres, avoiding pre learning processing for new styles and/or timbres, thereby improving style transfer ability and timbre transfer ability, and supporting the generalization processing of new styles and/or timbres.

At step 104, the trained speech synthesis model is obtained based on the trained semantic encoding network and the trained semantic decoding network.

With the method for training the speech synthesis model according to embodiment of the disclosure, the training data is obtained, in which the training samples in the training data include the style sample speech, the timbre sample speech, the input sample text, and the output sample speech; the initial speech synthesis model is obtained, in which the speech synthesis model includes a semantic encoding network and a semantic decoding network, the semantic encoding network and semantic decoding network are trained separately based on the style sample speech, the timbre sample speech, the input sample text, and the output sample speech, to obtain the trained semantic encoding network and the trained semantic decoding network; the trained speech synthesis model is obtained based on the trained semantic encoding network and the trained semantic decoding network. The style sample speech and the timbre sample speech have rich expressions, and combined with the semantic feature extraction of the semantic encoding network, more features may be extracted and fused into the synthesized output speech, thereby avoiding training for various styles and/or timbres, reducing the cost of training the speech synthesis model, and improving the generalization of the trained speech synthesis model on new styles and/or timbres.

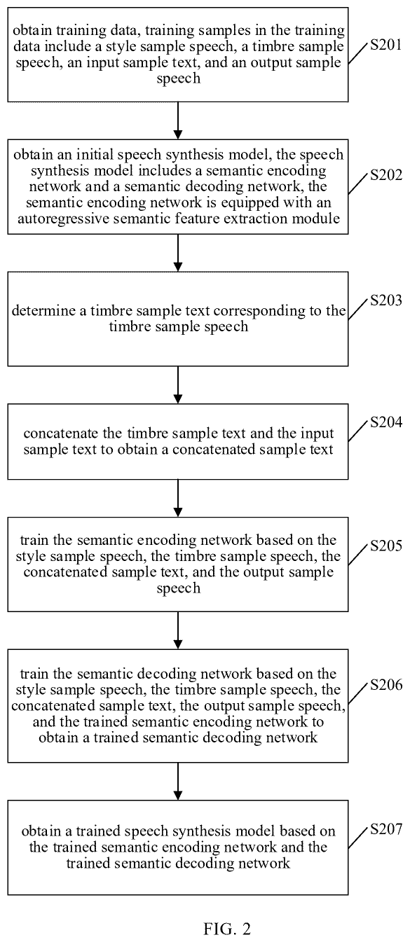

In order to further improve the efficiency of training the speech synthesis model and the accuracy of the trained speech synthesis model, an autoregressive semantic feature extraction module may be set in the semantic encoding network of the speech synthesis model, and the sample text inputted to the speech encoding network may be a concatenated text. The concatenated text is obtained by concatenating the timbre sample text corresponding to the timbre sample speech and the input sample text, thereby achieving autoregressive processing. As illustrated in FIG. 2, FIG. 2 is a schematic diagram according to a second embodiment of the disclosure. Embodiments illustrated in FIG. 2 may include the following.

At step 201, training data is obtained. Training samples in the training data include a style sample speech, a timbre sample speech, an input sample text, and an output sample speech.

At step 202, an initial speech synthesis model is obtained. The speech synthesis model includes a semantic encoding network and a semantic decoding network. The semantic encoding network is equipped with an autoregressive semantic feature extraction module.

At step 203, a timbre sample text corresponding to the timbre sample speech is determined.

In embodiments of the disclosure, a process of executing the step 203 on the electronic device may be, for example, inputting the timbre sample speech into a speech recognition model to obtain the timbre sample text outputted by the speech recognition model.

At step 204, the timbre sample text and the input sample text are concatenated to obtain a concatenated sample text.

To adapt to the autoregressive semantic feature extraction module to extract a semantic feature vector sequence corresponding to the input sample text by considering the timbre sample text, the electronic device may concatenate the timbre sample text and the input sample text by placing the timbre sample text before the input sample text to obtain the concatenated sample text.

At step 205, the semantic encoding network is trained based on the style sample speech, the timbre sample speech, the concatenated sample text, and the output sample speech.

In embodiments of the disclosure, a process of executing step 205 on the electronic device may be, for example, performing semantic feature extraction on the output sample speech to obtain an output semantic feature vector sequence; inputting the style sample speech, the timbre sample speech, and the concatenated sample text into the semantic encoding network to obtain an intermediate semantic feature vector sequence corresponding to the concatenated sample text outputted by the semantic encoding network; extracting a predicted semantic feature vector sequence corresponding to the input sample text from the intermediate semantic feature vector sequence; adjusting parameters of the semantic encoding network based on the predicted semantic feature vector sequence and the output semantic feature vector sequence, to obtain the trained semantic encoding network.

Adjusting the parameters of the semantic encoding network based on the predicted semantic feature vector sequence and the output semantic feature vector sequence may gradually reduce the difference between predicted semantic features outputted by the semantic encoding network and the output semantic feature vector sequence, thereby improving the accuracy of the trained semantic encoding network.

In embodiments of the disclosure, the semantic encoding network may include a style encoding module, a timbre encoding module, a text encoding module, and an autoregressive semantic feature extraction module. The autoregressive semantic feature extraction module is connected to the style encoding module, to the timbre encoding module, and to the text encoding module, respectively. The autoregressive semantic feature extraction module is configured to perform the semantic feature extraction based on a style representation vector outputted by the style encoding module, a timbre representation vector outputted by the timbre encoding module, and a text representation vector sequence outputted by the text encoding module, to obtain the semantic feature vector sequence.

A process that the electronic device inputs the style sample speech, the timbre sample speech, and the concatenated sample text into the semantic encoding network, to obtain the intermediate semantic feature vector sequence corresponding to the concatenated sample text outputted by the semantic encoding network may be, for example, performing the style encoding processing on the style sample speech by the style encoding module to obtain the style representation vector; performing the timbre encoding processing on the timbre sample speech by the timbre encoding module to obtain the timbre representation vector; performing the text encoding processing on the concatenated sample text by the text encoding module to obtain the text representation vector sequence; and performing the semantic feature extraction processing on the inputted style representation vector, the timbre representation vector, and the text representation vector sequence by the autoregressive semantic feature extraction module to obtain the intermediate semantic feature vector sequence.

The autoregressive semantic feature extraction module performs the semantic feature extraction processing based on the style representation vector outputted by the style encoding module, the timbre representation vector outputted by the timbre encoding module, and the text representation vector sequence outputted by the text encoding module, so that the extracted semantic feature vector sequence is fused with more style and timbre features, thereby achieving deep fusion of style and timbre features with text features, and further improving the accuracy of the trained semantic encoding network.

In embodiments of the disclosure, to enhance the style consistency between paragraphs in the concatenated sample text and/or between characters in the concatenated sample text, the respective positional vector of each character may be considered in determining the text representation vector sequence. Correspondingly, the processing way that the text encoding module processes the concatenated sample text may include the following: performing character encoding processing on each character in the concatenated sample text to obtain a character vector sequence; performing character position encoding on each character in the concatenated sample text and/or performing paragraph position encoding on a paragraph where each character is located to obtain a position vector sequence; concatenating character vectors in the character vector sequence and position vectors in the position vector sequence by character-wise concatenation to obtain the text representation vector sequence outputted by the text encoding module.

The character vector sequence may include respective character vectors corresponding to characters in the concatenated sample text. The position vector sequence may include respective position vectors corresponding to characters in the concatenated sample text. The electronic device may concatenate the character vectors and the position vectors corresponding to the characters in the concatenated sample text to obtain respective representation vectors corresponding to the characters; and combine the respective representation vectors corresponding to the characters to obtain the text representation vector sequence.

In embodiments of the disclosure, to further improve the accuracy of the determined predicted semantic feature vector sequence, in determining a respective semantic feature vector corresponding to each character, representation vectors of characters before that character may be considered. Correspondingly, the autoregressive semantic feature extraction module includes a sample context encoding module, a style gating control attention module, and a semantic output projection head module that are sequentially connected. The sample context encoding module is configured to determine, for each current character to be predicted in the concatenated sample text, a context representation vector corresponding to the current character based on the representation vector of the current character and representation vectors of characters before the current character. The style gating control attention module and the semantic output projection head module are configured to predict the semantic feature vector of the current character based on the context representation vector, the style representation vector, and the timbre representation vector.

A process of predicting the intermediate semantic feature vector sequence by the electronic device may be, for example, for each current character to be predicted in the concatenated sample text, obtaining the representation vector of the current character and the representation vectors of characters before the current character; performing context feature extraction on the representation vector of the current character and the representation vectors of the characters before the current character by the sample context encoding module to obtain the context representation vector corresponding to the current character; and performing semantic feature extraction on the context representation vector, the style representation vector, and the timbre representation vector by the style gating control attention module and by the semantic output projection head module, to obtain the semantic feature vector of the current character.

In a case where the current character is a first one of characters (or called first character) in the input sample text, the context representation vector corresponding to the first character may be determined by combining the representation vector of the first character with the representation vectors of characters in the timbre sample text in the concatenated sample text. This avoids using only the representation vector of the first character for semantic feature vector prediction processing, thereby further improving the accuracy of the predicted semantic feature vector of the first character.

In embodiments of the disclosure, to ensure a consistency in style trends between the semantic feature vectors of the characters, to make styles of semantic feature vectors in the predicted semantic feature vector sequence naturally change, the style gating control attention module is equipped with a historical semantic memory encoding module, an attention adjustment module, and a style adjustment gating unit that are sequentially connected, to extract a style trend based on an existing semantic feature vector sequence outputted by the autoregressive semantic feature extraction module. The extracted style trend is used for predicting the semantic feature vector of the current character.

An input of the historical semantic memory encoding module may be the existing semantic feature vector sequence outputted by the autoregressive semantic feature extraction module, and an output of the historical semantic memory encoding module may be a historical memory state. An input of the attention adjustment module may be the context representation vector corresponding to the current character and the historical memory state, and an output of the attention adjustment module may be the style trend. An input of the style adjustment gating unit may be the style trend, the style adjustment gating unit is configured to determine a style adjustment strategy for the current character and to predict the semantic feature vector of the current character by considering the style adjustment strategy. The style adjustment strategy may be, for example, continuation, enhancement, and transfer.

In embodiments of the disclosure, to improve the speed of training the semantic encoding network and enhance the accuracy of the trained semantic encoding network, the electronic device may determine a loss function value by considering a sub loss function in at least one dimension, the predicted semantic feature vector sequence, and the output semantic feature vector sequence, and adjust the parameters of the semantic encoding network. Correspondingly, a process that electronic devices adjusts the parameters of the semantic encoding network based on the predicted semantic feature vector sequence and the output semantic feature vector sequence may be, for example, determining at least one value for the sub loss function in the at least one dimension based on the predicted semantic feature vector sequence and the output semantic feature vector sequence, where the at least one dimension includes a style dimension, a timbre dimension, a semantic dimension, or a style consistency dimension, and adjusting the parameters of the semantic encoding network based on the at least one value of the sub loss function in the at least one dimension to obtain the trained semantic encoding network.

In embodiments of the disclosure, the value of the sub loss function in the style dimension is determined based on the style representation vector outputted by the style encoding module and a predicted style representation vector. The predicted style representation vector is obtained by extracting a style of the predicted semantic feature vector sequence.

A process of obtaining the predicted style representation vector by the electronic device may be, for example, inputting the predicted semantic feature vector sequence into the style extraction module, and obtaining the predicted style representation vector outputted by the style extraction module. The electronic device may determine a vector similarity based on the style representation vector and the predicted style representation vector, and determine a difference between the vector similarity and 1 as the value of the sub loss function in the style dimension.

The greater the vector similarity between the style representation vector and the predicted style representation vector, the smaller the value of the sub loss function in the style dimension.

The determination of the value of the sub loss function in the style dimension and the adjustment of the parameters of the semantic encoding network may guide the semantic encoding network to utilize more style features.

In embodiments of the disclosure, the value of the sub loss function in the timbre dimension is determined based on the timbre representation vector corresponding to the timbre sample speech and a predicted timbre representation vector. The predicted timbre representation vector is obtained by extracting timbre from the predicted semantic feature vector sequence.

A process of obtaining the predicted timbre representation vector by the electronic device may be, for example, inputting the predicted semantic feature vector sequence into the timbre extraction module to obtain the predicted timbre representation vector outputted by the timbre extraction module. The electronic device may determine a vector similarity based on the timbre representation vector and the predicted timbre representation vector, and determine a difference between the vector similarity and 1 as the value of the sub loss function in the timbre dimension.

The greater the vector similarity between the timbre representation vector and the predicted timbre representation vector, the smaller the value of the sub loss function in the timbre dimension.

The determination of the value of the sub loss function in the timbre dimension and the adjustment of the parameters of the semantic encoding network may guide the semantic encoding network to utilize more timbre features.

The value of the sub loss function in the semantic dimension is determined based on the predicted semantic feature vector sequence and the output semantic feature vector sequence.

The electronic device may determine a vector sequence similarity based on the predicted semantic feature vector sequence and the output semantic feature vector sequence, and determines a difference between the vector sequence similarity and 1 as the value of the sub loss function in the semantic dimension.

The greater the vector sequence similarity between the predicted semantic feature vector sequence and the output semantic feature vector sequence, the smaller the value of the sub loss function in the semantic dimension.

The value of the sub loss function in the style consistency dimension is determined based on predicted semantic feature vectors corresponding to adjacent characters in the predicted semantic feature vector sequence.

The electronic device may perform style feature extraction processing based on the predicted semantic feature vectors corresponding to adjacent characters to obtain style features corresponding to adjacent characters; determine a difference degree between the style features corresponding to adjacent characters; and determine the value of the sub loss function in the style consistency dimension based on each difference degree.

The difference degree is positively correlated with the value of the sub loss function in the style consistency dimension.

The determination of the value of the sub loss function in the style consistency dimension and the adjustment of the parameters of the semantic encoding network may guide the semantic encoding network to generate predicted semantic feature vector sequences with consistent style.

At step 206, the semantic decoding network is trained based on the style sample speech, the timbre sample speech, the concatenated sample text, the output sample speech, and the trained semantic encoding network to obtain a trained semantic decoding network.

At step 207, the trained speech synthesis model is obtained based on the trained semantic encoding network and the trained semantic decoding network.

It should be noted that for the detailed content of steps 201 to 202 and step 207, reference may be made to the steps 101 to 102 and step 104 in embodiments illustrated in FIG. 1, which are not repeated here.

With the method for training the speech synthesis model according to embodiments of the disclosure, training data is obtained, in which the training samples in the training data include the style sample speech, the timbre sample speech, the input sample text, and the output sample speech; the initial speech synthesis model is obtained, in which the speech synthesis model includes the semantic encoding network and the semantic decoding network, and the semantic encoding network is equipped with the autoregressive semantic feature extraction module; the timbre sample text corresponding to the timbre sample speech is determined, the timbre sample text and input sample text are concatenated to obtain the concatenated sample text, the semantic encoding network is trained based on the style sample speech, the timbre sample speech, the concatenated sample text, and the output sample speech; the semantic decoding network is trained based on the style sample speech, the timbre sample speech, the concatenated sample text, the output sample speech, and the trained semantic encoding network to obtain the trained semantic decoding network; and the trained speech synthesis model is obtained based on the trained semantic encoding network and the trained semantic decoding network. The semantic encoding network of the speech synthesis model is equipped with the autoregressive semantic feature extraction module, and the sample text inputted to the speech encoding network may be the text obtained by concatenating the timbre sample text corresponding to the timbre sample speech and the input sample text, thereby further improving the efficiency of training the speech synthesis model and the accuracy of the trained speech synthesis model.

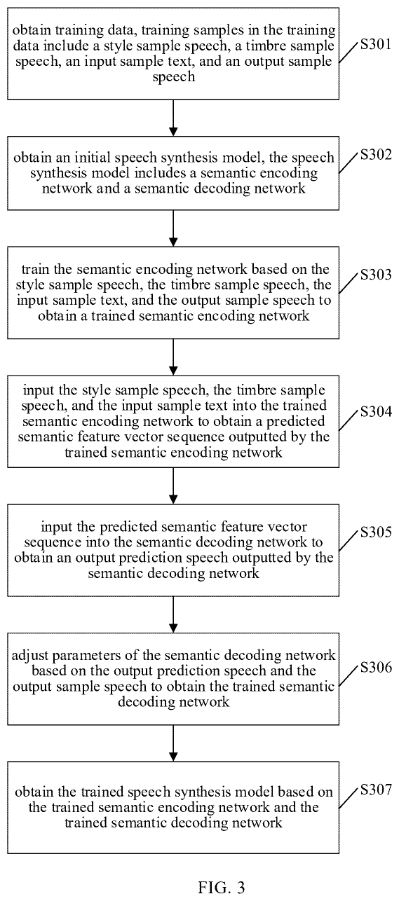

To further improve the efficiency of training the speech synthesis model and to enhance the accuracy of the trained speech synthesis model, parameters of the semantic decoding network may be adjusted by considering an output prediction speech outputted from the trained semantic encoding network and the output sample speech. As illustrated in FIG. 3, FIG. 3 is a schematic diagram according to a third embodiment of the disclosure. Embodiments illustrated in FIG. 3 may include the following.

At step 301, training data is obtained. Training samples in the training data include a style sample speech, a timbre sample speech, an input sample text, and an output sample speech.

At step 302, an initial speech synthesis model is obtained. The speech synthesis model includes a semantic encoding network and a semantic decoding network.

At step 303, the semantic encoding network is trained based on the style sample speech, the timbre sample speech, the input sample text, and the output sample speech to obtain a trained semantic encoding network.

At step 304, the style sample speech, the timbre sample speech, and the input sample text are inputted into the trained semantic encoding network to obtain a predicted semantic feature vector sequence outputted by the trained semantic encoding network.

In embodiments of the disclosure, as an alternative, the input sample text in step 304 may be replaced with a concatenated sample text, and then processing of other steps may be performed. The concatenated sample text is obtained by concatenating the timbre sample text corresponding to the timbre sample speech and the input sample text.

At step 305, the predicted semantic feature vector sequence is inputted into the semantic decoding network to obtain an output prediction speech outputted by the semantic decoding network.

In embodiments of the disclosure, to further improve a consistency between style features used in the processing performed by the semantic encoding network and the style features used in the processing performed by the semantic decoding network, the electronic device may perform the process of step 305, for example, by obtaining the style representation vector corresponding to the style sample speech; inputting the style representation vector and the predicted semantic feature vector sequence into the semantic decoding network to obtain the output prediction speech outputted by the semantic decoding network.

The semantic decoding network includes a semantic decoding module and a vocoder. The semantic decoding module is configured to decode the semantic feature vector sequence and the style representation vector to obtain the predicted acoustic feature sequence. The vocoder is configured to perform speech generation processing based on the acoustic feature sequence to obtain the output prediction speech.

A format of the predicted acoustic feature sequence may be, for example, mel spectral acoustic feature sequence. It should be noted that different formats of predicted acoustic feature sequences may be processed using different vocoders for speech generation.

At step 306, the parameters of the semantic decoding network are adjusted based on the output prediction speech and the output sample speech to obtain the trained semantic decoding network.

In embodiments of the disclosure, to further improve the speed of training the semantic decoding network and enhance the accuracy of the trained semantic decoding network, the electronic device may determine sub loss function values by considering at least one value of the sub loss function in at least one dimension, the output prediction speech, and adjust the parameters of the semantic encoding network. Correspondingly, the process of executing step 306 on the electronic device may be, for example, determining at least one value of the sub loss function in the at least one dimension based on the output prediction speech and output sample speech, where the at least one dimension includes a speech dimension, a speech prosody dimension, or a speech consistency dimension, and adjusting the parameters of the semantic decoding network based on the at least one value of the sub loss function in the at least one dimension to obtain the trained semantic decoding network.

In embodiments of the disclosure, the value of the sub loss function in the speech dimension is determined based on a speech similarity between the output prediction speech and the output sample speech.

The speech similarity between the output prediction speech and the output sample speech may be determined based on an overlap degree between speech frames of the output prediction speech and speech frames of the output sample speech, or may be determined based on a similarity between a speech vector of the output prediction speech and a speech vector of the output sample speech.

In embodiments of the disclosure, the value of the sub loss function in the speech prosody dimension is determined based on predicted prosody data and sample prosody data. The predicted prosody data is obtained by extracting prosody from the output prediction speech, and the sample prosody data is obtained by extracting prosody from the output sample speech.

The prosody data may include parameter data corresponding to at least one of following parameters: fundamental frequency parameter, duration parameter, sound intensity parameter, or the like. The fundamental frequency parameter may be, such as, a fundamental frequency. The duration parameter may be, such as, a duration of pronunciation of phonemes, syllables, or words in the speech. The sound intensity parameter may be, such as, amplitude or energy in the speech.

The electronic device may determine a respective loss value per each parameter based on the parameter data mentioned above; and apply weighted sum to the respective loss value per each parameter to obtain the value of the sub loss function in the speech prosody dimension.

In embodiments of the disclosure, the value of the sub loss function in the speech consistency dimension is determined based on a difference between adjacent speech frames in the output prediction speech.

The electronic device may determine a smoothness between adjacent speech frames in the output prediction speech, determine the smoothness as the difference between adjacent speech frames, and determine the value of the sub loss function in the speech consistency dimension based on each difference.

At step 307, the trained speech synthesis model is obtained based on the trained semantic encoding network and the trained semantic decoding network.

It should be noted that for the detailed content of steps 301 to 302 and step 307, reference may be made to steps 101 to 102 and step 104 in embodiments illustrated in FIG. 1, which are not repeated here.

With the method for training the speech synthesis model according to embodiments of the disclosure, the training data is obtained, where training samples in the training data include the style sample speech, the timbre sample speech, the input sample text, and the output sample speech; the initial speech synthesis model is obtained, where the speech synthesis model includes the semantic encoding network and the semantic decoding network; the semantic encoding network is trained based on the style sample speech, the timbre sample speech, the input sample text, and the output sample speech to obtain the trained semantic encoding network; the style sample speech, the timbre sample speech, and the input sample text are inputted into the trained semantic encoding network to obtain the predicted semantic feature vector sequence outputted by the trained semantic encoding network; the predicted semantic feature vector sequence is inputted into the semantic decoding network to obtain the output prediction speech outputted by the semantic decoding network; the parameters of the semantic decoding network are adjusted based on the output prediction speech and output the sample speech, to obtain the trained semantic decoding network; and the trained speech synthesis model is obtained based on the trained semantic encoding network and the trained semantic decoding network. By considering the output prediction speech outputted by the trained semantic encoding network and the output sample speech, the parameters of the semantic decoding network are adjusted, which may further improve the efficiency of training the speech synthesis model and improve the accuracy of the trained speech synthesis model.

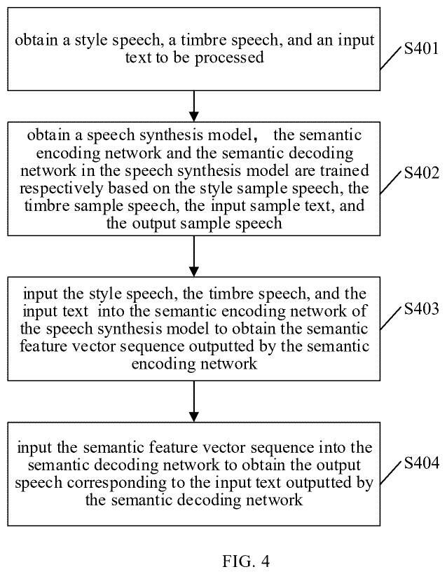

FIG. 4 is a schematic diagram according to a fourth embodiment of the disclosure. It should be noted that the speech synthesis method of the disclosure may be performed by a speech synthesis device. The speech synthesis device may be provided in an electronic device to enable the electronic device to perform speech synthesis functions.

The electronic device may be any device with computing power, such as a personal computer (PC), a mobile terminal, a server, or the like. The mobile terminal may be a hardware device with various operating systems, touch screens, and/or display screens, such as a vehicle-mounted device, a mobile phone, a tablet, a personal digital assistant, a wearable device, a smart speaker, a server, a server cluster, or the like.

The speech synthesis device may also be software in the electronic device, such as speech synthesis software. In following embodiments, the execution subject is an electronic device as an example for explanation.

As illustrated in FIG. 4, the speech synthesis method may include the following.

At step 401, a style speech, a timbre speech, and an input text to be processed are obtained.

In embodiments of the disclosure, the speech synthesis method may be applied to at least one of following scenarios: intelligent dialogue scenario, audio content creation scenario, game and virtual human scenario, assistive technology scenario, or mental health and education scenario.

The intelligent dialogue scenario may be, for example, AI assistant, virtual companion application, customer service conversation, enterprise digital employee, voice assistant, or the like. The audio content creation scenario may be, such as, novel audio system, film and television script dubbing, short video narration, or the like. The assistive technology scenario may be, such as an assistive application for visually impaired individuals or an assistance for people with language barriers. The mental health and educational scenario may be, such as, language learning, psychological education, or the like.

The style speech, the timbre speech, and the input text to be processed may be the data that needs to be processed for speech synthesis in above-mentioned scenarios.

The style speech may have a style, such as easy and humor without losing organization, comforting warmly like a friend, or the like. The style speech refers to a speech obtained by reading loudly the text using the aforementioned style.

The timbre speech may have a timbre, such as the timbre of an object. The timbre speech refers to a speech obtained by reading loudly the text by an object with a certain timbre.

At step 402, a speech synthesis model is obtained. The semantic encoding network and semantic decoding network in the speech synthesis model are trained respectively based on the style sample speech, the timbre sample speech, the input sample text, and the output sample speech.

In embodiments of the disclosure, the semantic encoding network is configured to perform semantic feature vector sequence extraction based on the style sample speech, the timbre sample speech, and the input sample text, to obtain the predicted semantic feature vector sequence. The semantic decoding network is configured to perform semantic decoding processing on the predicted semantic feature vector sequence to obtain the output prediction speech.

In embodiments of the disclosure, the semantic encoding network may include a style encoding module, a timbre encoding module, a text encoding module, and an autoregressive semantic feature extraction module. The autoregressive semantic feature extraction module is connected to the style encoding module, the timbre encoding module, and the text encoding module, respectively. The autoregressive semantic feature extraction module is configured to perform semantic feature extraction based on a style representation vector outputted by the style encoding module, a timbre representation vector outputted by the timbre encoding module, and a text representation vector sequence outputted by the text encoding module, to the semantic feature vector sequence.

In embodiments of the disclosure, the autoregressive semantic feature extraction module includes a sample context encoding module, a style gating control attention module, and a semantic output projection head module that are sequentially connected. The sample context encoding module is configured to determine, for each current character to be predicted in the concatenated sample text, a context representation vector corresponding to the current character based on the representation vector of the current character and representation vectors of characters before the current character. The style gating control attention module and the semantic output projection head module are configured to predict the semantic feature vector of the current character based on the context representation vector, the style representation vector, and the timbre representation vector.

In embodiments of the disclosure, to ensure a consistency in style trends between the semantic feature vectors of the characters, to make styles of semantic feature vectors in the predicted semantic feature vector sequence naturally change, the style gating control attention module is equipped with a historical semantic memory encoding module, an attention adjustment module, and a style adjustment gating unit that are sequentially connected, to extract a style trend based on an existing semantic feature vector sequence outputted by the autoregressive semantic feature extraction module. The extracted style trend is used for predicting the semantic feature vector of the current character.

For the process of training the semantic encoding network and the semantic decoding network based on the style sample speech, the timbre sample speech, the input sample text, and the output sample speech by the electronic device, reference may be made to embodiments in FIGS. 1 to 3, which are not repeated here.

At step 403, the style speech, the timbre speech, and the input text are inputted into the semantic encoding network of the speech synthesis model to obtain the semantic feature vector sequence outputted by the semantic encoding network.

In embodiments of the disclosure, to adapt to the autoregressive semantic feature extraction module to extract the semantic feature vector sequence corresponding to the input sample text by considering the timbre sample text, the electronic device may concatenate the timbre sample text and the input sample text by placing the timbre sample text before the input sample text to obtain the concatenated sample text, and may input the style speech, the timbre speech, and the concatenated sample text into the semantic encoding network of the speech synthesis model to obtain the semantic feature vector sequence outputted by the semantic encoding network.

At step 404, the semantic feature vector sequence is inputted into the semantic decoding network to obtain the output speech corresponding to the input text outputted by the semantic decoding network.

With the speech synthesis method according to embodiments of the disclosure, the style speech, the timbre speech, and the input text to be processed are obtained; the speech synthesis model is obtained; the semantic encoding network and semantic decoding network in the speech synthesis model are trained respectively based on the style sample speech, the timbre sample speech, the input sample text, and the output sample speech; the style speech, the timbre speech, and the input text are inputted into the semantic encoding network of the speech synthesis model, to obtain the semantic feature vector sequence outputted by the semantic encoding network; the semantic feature vector sequence is inputted into the semantic decoding network, to obtain the output speech corresponding to the input text outputted by the semantic decoding network. The semantic encoding network and the semantic decoding network are trained respectively based on the style sample speech, the timbre sample speech, the input sample text, and the output sample speech, such that the semantic encoding network may extract more features from the style speech and the timbre speech, fuse them into the semantic feature vector sequence, and decode them to obtain the output speech, which may be applied to new styles and/or timbres, thereby improving the efficiency of speech synthesis.

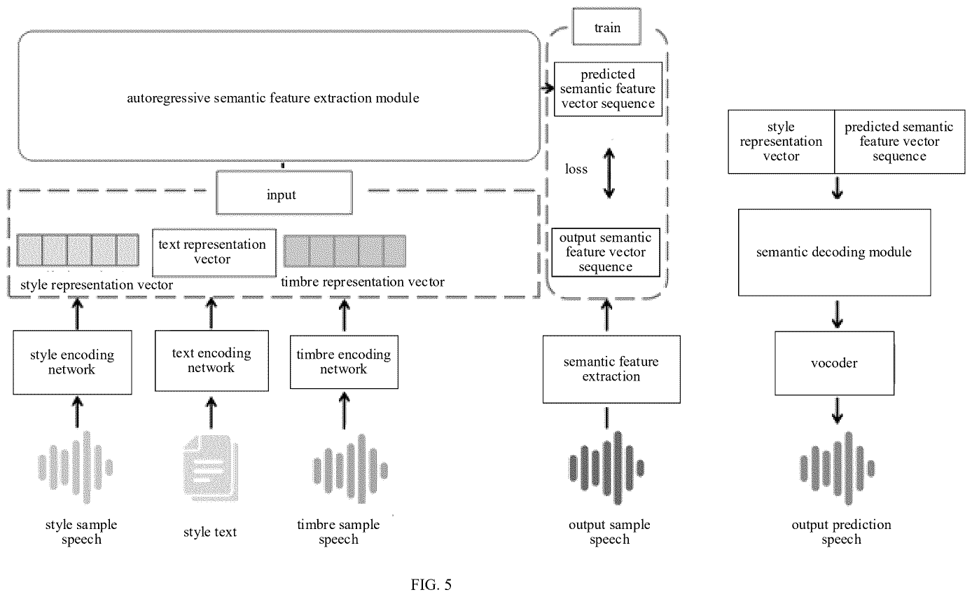

Here are some examples to illustrate. As illustrated in FIG. 5, FIG. 5 is a schematic diagram illustrating a framework of the speech synthesis model. In FIG. 5, the speech synthesis model includes a semantic encoding network and a semantic decoding network. The semantic encoding network includes: a style encoding module, a text encoding module, a timbre encoding module, and an autoregressive semantic feature extraction module. The semantic decoding network includes: a semantic decoding module and a vocoder.

The style encoding module is configured to encode the style sample speech to obtain a style representation vector. The text encoder is configured to encode the sample text to obtain a text representation vector. The timbre encoding module is configured to encode the timbre sample speech to obtain a timbre representation vector.

The autoregressive semantic feature extraction module is configured to perform semantic feature extraction on the style representation vector, the text representation vector, and the timbre representation vector to obtain a predicted semantic feature vector sequence.

The semantic decoding module is configured to decode the predicted semantic feature vector sequence and the style representation vector to obtain a predicted acoustic feature sequence. The vocoder is configured to perform speech generation processing based on the predicted acoustic feature sequence to obtain an output prediction speech.

The loss function of the semantic encoding network may be constructed based on the output semantic feature vector sequence extracted from the output sample speech and the predicted semantic feature vector sequence outputted by the semantic encoding network.

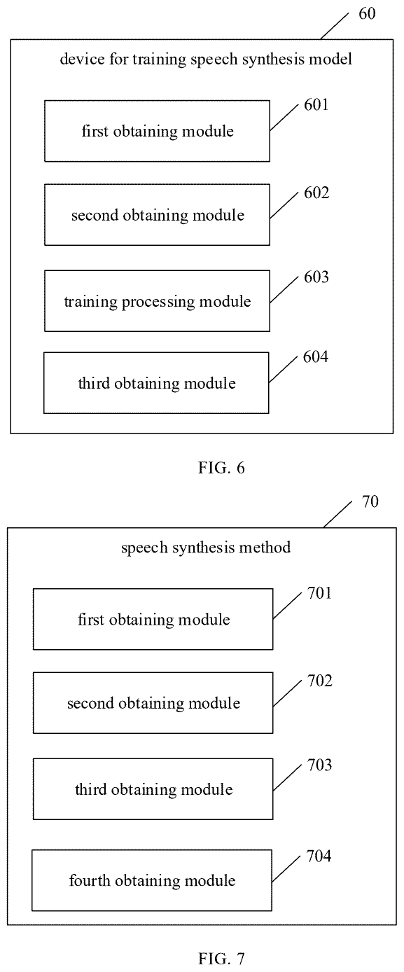

To implement the above embodiments, the disclosure also provides a device for training a speech synthesis model. As illustrated in FIG. 6, FIG. 6 is a schematic diagram according to a fifth embodiment of the disclosure. The training device 60 of the speech synthesis model may include a first obtaining module 601, a second obtaining module 602, a training processing module 603, and a third obtaining module 604.

The first obtaining module 601 is configured to obtain training data. Training samples in the training data include a style sample speech, a timbre sample speech, an input sample text, and an output sample speech. The second obtaining module 602 is configured to obtain an initial speech synthesis model. The speech synthesis model includes a semantic encoding network and a semantic decoding network. The training processing module 603 is configured to train the semantic encoding network and the semantic decoding network respectively based on the style sample speech, the timbre sample speech, the input sample text, and the output sample speech, to obtain the trained semantic encoding network and the trained semantic decoding network. The third obtaining module 604 is configured to obtain the trained speech synthesis model based on the trained semantic encoding network and the trained semantic decoding network.

As an implementation of embodiments of the disclosure, the first obtaining module 601 includes: a first obtaining unit, a second obtaining unit, and a generating unit. The first obtaining unit is configured to obtain the style sample speech, the timbre sample speech, and the input sample text. The second obtaining unit is configured to obtain a reference style speech and a reference timbre speech. A style of the reference style speech is the same as a style of the style sample speech. A timbre of the reference timbre speech is the same as a timbre of the timbre sample speech. A text corresponding to the reference timbre speech is the input sample text. The generating unit is configured to generate the output sample speech based on the reference style speech and the reference timbre speech.

As an implementation of embodiments of the disclosure, the first obtaining unit is configured to obtain a style description sample text, the timbre sample speech, and the input sample text; to obtain a style speech database, where the style speech database includes at least one style description text and a respective style speech corresponding to each style description text; to query the style speech database based on the style description sample text to obtain a first style description sample that matches the style description sample text in the style speech database; and determine the style speech corresponding to the first style description sample as the style sample speech.

As an implementation of embodiments of the disclosure, the semantic encoding network is equipped with an autoregressive semantic feature extraction module. The training processing module 603 includes: a determining unit, a concatenating unit, and a training processing unit. The determining unit is configured to determine a timbre sample text corresponding to the timbre sample speech. The concatenating unit is configured to concatenate the timbre sample text and the input sample text to obtain a concatenated sample text. The training processing unit is configured to train the semantic encoding network based on the style sample speech, the timbre sample speech, the concatenated sample text, and the output sample speech.

As an implementation of embodiments of the disclosure, the training processing unit is configured to perform semantic feature extraction on the output sample speech to obtain an output semantic feature vector sequence; input the style sample speech, the timbre sample speech, and the concatenated sample text into the semantic encoding network, to obtain an intermediate semantic feature vector sequence corresponding to the concatenated sample text outputted by the semantic encoding network; extract a predicted semantic feature vector sequence corresponding to the input sample text from the intermediate semantic feature vector sequence; and adjust parameters of the semantic encoding network based on the predicted semantic feature vector sequence and the output semantic feature vector sequence, to obtain the trained semantic encoding network.

As an implementation of embodiments of the disclosure, the semantic encoding network includes: a style encoding module, a timbre encoding module, a text encoding module, and the autoregressive semantic feature extraction module. The training processing unit is configured to perform style encoding processing on the style sample speech via the style encoding module to obtain a style representation vector; to perform timbre encoding processing on the timbre sample speech via the timbre encoding module to obtain a timbre representation vector; to perform text encoding processing on the concatenated sample text via the text encoding module to obtain a text representation vector sequence; and to perform semantic feature extraction on inputted style representation vector, the timbre representation vector, and the text representation vector sequence via the autoregressive semantic feature extraction module to obtain the intermediate semantic feature vector sequence.

As an implementation of embodiments of the disclosure, processing the concatenated sample text by the text encoding module includes: performing character encoding processing on each character in the concatenated sample text to obtain a character vector sequence; performing character position encoding on each character in the concatenated sample text and/or performing paragraph position encoding on a paragraph in which each character is located to obtain a position vector sequence; concatenating character vectors in the character vector sequence and position vectors in the position vector sequence by character-wise concatenation to obtain the text representation vector sequence outputted by the text encoding module.

As an implementation of embodiments of the disclosure, the autoregressive semantic feature extraction module includes a sample context encoding module, a style gating control attention module, and a semantic output projection head module that are sequentially connected. The training processing unit is configured to obtain, for each current character to be predicted in the concatenated sample text, a respective representation vector of the character and representation vectors of characters before the current character; perform context feature extraction on the representation vector of the current character and the representation vectors of the characters before the current character via the sample context encoding module to obtain the context representation vector corresponding to the current character; perform semantic feature extraction on the context representation vector, the style representation vector, and the timbre representation vector via the style gating control attention module and the semantic output projection head module, to obtain the semantic feature vector of the current character.

As an implementation of embodiments of the disclosure, the style gating control attention module is equipped with a historical semantic memory encoding module, an attention adjustment module, and a style adjustment gating unit that are sequentially connected, configured to extract a style trend based on an existing semantic feature vector sequence outputted by the autoregressive semantic feature extraction module, where the extracted style trend is used for predicting the semantic feature vector of the current character.

As an implementation of embodiments of the disclosure, the training processing unit is further configured to determine a value of a sub loss function in at least one dimension based on the predicted semantic feature vector sequence and the output semantic feature vector sequence, where the at least one dimension includes a style dimension, a timbre dimension, a semantic dimension, or a style consistency dimension; and to adjust parameters of the semantic encoding network based on the value of the sub loss function in the at least one dimension to obtain the trained semantic encoding network.

As an implementation of embodiments of the disclosure, the value of the sub loss function in the style dimension is determined based on the style representation vector outputted by the style encoding module and the predicted style representation vector. The predicted style representation vector is obtained by extracting a style of the predicted semantic feature vector sequence. The value of the sub loss function in the timbre dimension is determined based on the timbre representation vector corresponding to the timbre sample speech and the predicted timbre representation vector. The predicted timbre representation vector is obtained by extracting a timbre from the predicted semantic feature vector sequence. The value of the sub loss function in the semantic dimension is determined based on the predicted semantic feature vector sequence and the output semantic feature vector sequence. The value of the sub loss function in the style consistency dimension is determined based on predicted semantic feature vectors corresponding to adjacent characters in the predicted semantic feature vector sequence.

As an implementation of embodiments of the disclosure, the training processing module 603 further includes: a third obtaining unit and a fourth obtaining unit. The third obtaining unit is configured to input the style sample speech, the timbre sample speech, and the input sample text into the trained semantic encoding network, to obtain the predicted semantic feature vector sequence outputted by the trained semantic encoding network. The fourth obtaining unit is configured to input the predicted semantic feature vector sequence into the semantic decoding network to obtain the output prediction speech outputted by the semantic decoding network. The training processing unit is further configured to adjust the parameters of the semantic decoding network based on the output prediction speech and the output sample speech, to obtain the trained semantic decoding network.

As an implementation of embodiments of the disclosure, the fourth obtaining unit is further configured to obtain the style representation vector corresponding to the style sample speech; and to input the style representation vector and the predicted semantic feature vector sequence into the semantic decoding network, to obtain the output prediction speech outputted by the semantic decoding network.

As an implementation of embodiments of the disclosure, the training processing unit is further configured to determine the value of sub loss function in at least one dimension based on the output prediction speech and the output sample speech, where the at least one dimension includes a speech dimension, a speech prosody dimension, or speech consistency dimension; and to adjust the parameters of the semantic decoding network based on the value of the sub loss function in the at least one dimension to obtain the trained semantic decoding network.

As an implementation of embodiments of the disclosure, the value of the sub loss function in the speech dimension is determined based on a speech similarity between the output prediction speech and the output sample speech. The value of the sub loss function in the speech prosody dimension is determined based on predicted prosody data and sample prosody data, where the predicted prosody data is obtained by extracting prosody from the output prediction speech, and the sample prosody data is obtained by extracting prosody from the output sample speech. The value of the sub loss function in the speech consistency dimension is determined based on a difference between adjacent speech frames in the output prediction speech.

With the device for training the speech synthesis model according to embodiments of the disclosure, the training data is obtained, where the training samples in the training data include the style sample speech, the timbre sample speech, the input sample text, and the output sample speech; the initial speech synthesis model is obtained, where the speech synthesis model includes the semantic encoding network and the semantic decoding network; the semantic encoding network and the semantic decoding network are trained respectively based on the style sample speech, the timbre sample speech, the input sample text, and the output sample speech, to obtain the trained semantic encoding network and the trained semantic decoding network; and the trained speech synthesis model is obtained based on the trained semantic encoding network and the trained semantic decoding network. The style sample speech and the timbre sample speech have rich expressions, and more features may be extracted and fused into the synthesized output speech by considering the semantic feature extraction performed by the semantic encoding network, thereby avoiding training for various styles and/or timbres, reducing the cost of training the speech synthesis model, and improving the generalization of the trained speech synthesis model on new styles and/or timbres.

To implement above embodiments, the disclosure also provides a speech synthesis device. As illustrated in FIG. 7, FIG. 7 is a schematic diagram according to a sixth embodiment of the disclosure. The speech synthesis device 70 may include a first obtaining module 701, a second obtaining module 702, a third obtaining module 703, and a fourth obtaining module 704.

The first obtaining module 701 is configured to obtain a style speech, a timbre speech, and an input text to be processed. The second obtaining module 702 is configured to obtain a speech synthesis model. The semantic encoding network and semantic decoding network in the speech synthesis model are trained respectively based on the style sample speech, the timbre sample speech, the input sample text, and the output sample speech. The third obtaining module 703 is configured to input the style speech, the timbre speech, and the input text into the semantic encoding network of the speech synthesis model, to obtain a semantic feature vector sequence outputted by the semantic encoding network. The fourth obtaining module 704 is configured to input the semantic feature vector sequence into the semantic decoding network, to obtain an output speech corresponding to the input text outputted by the semantic decoding network.

With the speech synthesis device according to embodiments of the disclosure, the style speech, the timbre speech, and the input text to be processed are obtained; the speech synthesis model is obtained; the semantic encoding network and semantic decoding network in the speech synthesis model are trained respectively based on the style sample speech, the timbre sample speech, the input sample text, and the output sample speech; the style speech, the timbre speech, and the input text are inputted into the semantic encoding network of the speech synthesis model to obtain the semantic feature vector sequence outputted by the semantic encoding network; the semantic feature vector sequence is inputted into the semantic decoding network to obtain the output speech corresponding to the input text outputted by the semantic decoding network. The semantic encoding network and the semantic decoding network are trained respectively based on the style sample speech, the timbre sample speech, the input sample text, and the output sample speech, so that the semantic encoding network may extract more features from the style speech and the timbre speech, fuse them into the semantic feature vector sequence, and decode them to obtain the output speech, which may be applied to new styles and/or timbres, thereby improving the efficiency of speech synthesis.

In embodiments of the disclosure, the collection, storage, use, processing, transmission, provision, and disclosure of user personal information are all carried out with the user's consent, in compliance with relevant laws and regulations, and do not violate public order and good customs.

According to embodiments of the disclosure, the disclosure also provides an electronic device, a readable storage medium, and a computer program product.

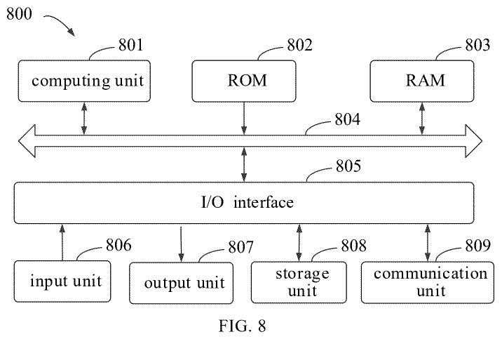

FIG. 8 is a schematic block diagram illustrating an example electronic device 800 that is used to implement embodiments of the disclosure. The electronic device aims to represent various forms of digital computers, such as laptops, desktop computers, workbenches, personal digital assistants, servers, blade servers, mainframe computers, and other suitable computers. The electronic device may also represent various forms of mobile devices, such as personal digital processing, cellular phones, smartphones, wearable devices, and other similar computing devices. The components, their connections and relationships, and their functions in embodiments of the disclosure are only examples and are not intended to limit implementations of the disclosure described and/or required here.

As illustrated in FIG. 8, the electronic device 800 includes a computing unit 801 that may perform various appropriate actions and processes based on computer programs stored in read-only memory (ROM) 802 or computer programs loaded from a storage unit 808 into a random access memory (RAM) 803. In RAM 803, various programs and data required for the operation of electronic device 800 may also be stored. The computing unit 801, the ROM 802, and the RAM 803 are connected to each other through a bus 804. The input/output (I/O) interface 805 is also connected to the bus 804.

Multiple components in the electronic device 800 are connected to the I/O interface 805, including an input unit 806 (such as keyboard, mouse, or the like), an output unit 807 (such as various types of displays, speakers, or the like), a storage unit 808 (such as disks, CDs, or the like), and a communication unit 809 (such as a network card, a modem, a wireless communication transceiver, or the like). The communication unit 809 allows the electronic device 800 to exchange information/data with other devices through computer networks such as the Internet and/or various telecommunications networks.

The computing unit 801 may be various general-purpose and/or specialized processing components with processing and computing capabilities. Some examples of the computing unit 801 include, but are not limited to, central processing units (CPUs), graphics processing units (GPUs), various specialized artificial intelligence (AI) computing chips, various computing units that run machine learning model algorithms, digital signal processors (DSPs), and any suitable processors, controllers, microcontrollers, or others. The computing unit 801 executes various methods and processes described above, such as the method for training the speech synthesis model or the speech synthesis method. For example, in some embodiments, the method for training the speech synthesis model or the speech synthesis method may be implemented as a computer software program tangibly contained in a machine-readable medium, such as storage unit 808. In some embodiments, some or all of the computer program may be loaded and/or installed onto the electronic device 800 via the ROM 802 and/or the communication unit 809. When the computer program is loaded into the RAM 803 and executed by the computing unit 801, one or more steps of the method for training the speech synthesis model or the speech synthesis method described above may be performed. In other embodiments, the computing unit 801 may be configured to perform the method for training the speech synthesis model or the speech synthesis method through any other suitable means (e.g., by means of firmware).

Various implementations of the system and technologies described above in the disclosure may be implemented in digital electronic circuit systems, integrated circuit systems, field programmable gate arrays (FPGAs), application specific integrated circuits (ASICs), application specific standard products (ASSPs), system on chip (SOC), load programmable logic devices (CPLDs), computer hardware, firmware, software, and/or combinations thereof. These various implementations may include: implementing in one or more computer programs, the one or more computer programs being executable and/or interpretable on a programmable system including at least one programmable processor, which may be a dedicated or general-purpose programmable processor, receiving data and instructions from a storage system, from at least one input device, and from at least one output device, and transmitting the data and instructions to the storage system, to the at least one input device, and to the at least one output device.

Program codes used for implementing the methods of the disclosure may be written in any combination of one or more programming languages. These program codes may be provided to processors or controllers of general-purpose computers, specialized computers, or other programmable data processing devices, so that when executed by the processor or controller, the program codes implement the functions/operations specified in the flowchart and/or block diagram. The program codes may be executed entirely on a machine, partially on a machine, partially on a machine as a standalone software package, partially on a remote machine, or entirely on a remote machine or server.

In the disclosure, a machine-readable medium may be a tangible medium that contains or stores programs for use by or in combination with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or equipment, or any suitable combination of the above. More specific examples of machine-readable storage medium include electrical connections based on one or more wires, portable computer disks, hard drives, random access memory (RAM), read-only memory (ROM), erasable programmable read-only memory (EPROM or flash memory), optical fibers, compact disc read-only memory (CD-ROM), optical storage devices, magnetic storage devices, or any suitable combination of the above.

To provide interaction with the user, the system and technology of the disclosure may be implemented on a computer equipped with a display device (e.g. cathode ray tube (CRT) or liquid crystal display (LCD) monitor) for displaying information to the user, and a keyboard and pointing device (such as a mouse or trackball), through which users may provide input to the computer. Other types of devices may also be used to provide interaction with users. For example, feedback provided to users may be any form of sensory feedback (such as visual feedback, auditory feedback, or tactile feedback); and an input from the user in any form, including sound input, speech input, or tactile input may be received.

The systems and technologies described herein may be implemented in computing systems that include backend components (such as data servers), middleware components (such as application servers), frontend components (such as user computers with graphical user interfaces or web browsers, through which users can interact with the implementation of the systems and technologies described herein), or any combination of such backend components, middleware components, or frontend components. Components of the system may be interconnected through any form or medium of digital data communication, such as a communication network. Examples of communication networks include local area networks (LANs), wide area networks (WANs), and the Internet.

The computer system may include a client and a server. The client and server are generally far apart from each other and typically interact through a communication network. A client-server relationship is generated by running computer programs that have a client-server relationship with each other on corresponding computers. The server may be a cloud server, a distributed system server, or a server that combines blockchain technology.

It should be understood that various forms of processes above may be used to reorder, add, or delete steps. For example, the steps in the disclosure may be executed in parallel, sequentially, or in different orders, as long as they may achieve the desired results of the technical solution in the disclosure, and the disclosure does not impose any restrictions.

The above specific implementations do not constitute limitations on the scope of protection of the disclosure. Technicians in this field should understand that various modifications, combinations, sub combinations, and substitutions may be made based on design requirements and other factors. Any modifications, equivalent substitutions, and improvements made within the spirit and principles of this disclosure shall be included within the scope of protection of the disclosure.

What is claimed is:

1. A method for training a speech synthesis model, the method comprising:
obtaining training data, wherein training samples in the training data comprise a style sample speech, a timbre sample speech, an input sample text, and an output sample speech;
obtaining an initial speech synthesis model, wherein the initial speech synthesis model comprises a semantic encoding network and a semantic decoding network;
training the semantic encoding network and the semantic decoding network respectively based on the style sample speech, the timbre sample speech, the input sample text, and the output sample speech, to obtain a trained semantic encoding network and a trained semantic decoding network; and
obtaining a trained speech synthesis model based on the trained semantic encoding network and the trained semantic decoding network.

2. The method of claim 1, wherein obtaining the training data comprises:
obtaining the style sample speech, the timbre sample speech, and the input sample text;
obtaining a reference style speech and a reference timbre speech, wherein a style of the reference style speech is same as a style of the style sample speech; a timbre of the reference timbre speech is same as a timbre of the timbre sample speech, and a text corresponding to the reference timbre speech is the input sample text; and
generating the output sample speech based on the reference style speech and the reference timbre speech.

3. The method of claim 2, wherein obtaining the style sample speech, the timbre sample speech, and the input sample text comprises:
obtaining a style description sample text, the timbre sample speech, and the input sample text;
obtaining a style speech database, wherein the style speech database comprises at least one style description text and a respective style speech corresponding to each style description text;
querying the style speech database based on the style description sample text to obtain a first style description sample that matches the style description sample text from the style speech database; and
determining a style speech corresponding to the first style description sample as the style sample speech.

4. The method of claim 1, wherein an autoregressive semantic feature extractor is provided in the semantic encoding network; and training the semantic encoding network based on the style sample speech, the timbre sample speech, the input sample text, and the output sample speech comprises:
determining a timbre sample text corresponding to the timbre sample speech;
concatenating the timbre sample text and the input sample text to obtain a concatenated sample text; and
training the semantic encoding network based on the style sample speech, the timbre sample speech, the concatenated sample text, and the output sample speech.

5. The method of claim 4, wherein training the semantic encoding network based on the style sample speech, the timbre sample speech, the concatenated sample text, and the output sample speech comprises:
performing semantic feature extraction on the output sample speech to obtain an output semantic feature vector sequence;
inputting the style sample speech, the timbre sample speech, and the concatenated sample text into the semantic encoding network to obtain an intermediate semantic feature vector sequence corresponding to the concatenated sample text outputted by the semantic encoding network;
extracting a predicted semantic feature vector sequence corresponding to the input sample text from the intermediate semantic feature vector sequence; and
adjusting a parameter of the semantic encoding network based on the predicted semantic feature vector sequence and the output semantic feature vector sequence, to obtain a trained semantic encoding network.

6. The method of claim 5, wherein the semantic encoding network comprises a style encoder, a timbre encoder, a text encoder, and the autoregressive semantic feature extractor; and wherein inputting the style sample speech, the timbre sample speech, and the concatenated sample text into the semantic encoding network to obtain the intermediate semantic feature vector sequence corresponding to the concatenated sample text outputted by the semantic encoding network comprises:
performing style encoding processing on the style sample speech via the style encoder to obtain a style representation vector;
performing timbre encoding processing on the timbre sample speech via the timbre encoder to obtain a timbre representation vector;
performing text encoding processing on the concatenated sample text via the text encoder to obtain a text representation vector sequence; and
performing extract semantic feature extraction on the style representation vector, the timbre representation vector, and the text representation vector sequence via the autoregressive semantic feature extractor to obtain the intermediate semantic feature vector sequence.

7. The method of claim 6, wherein performing the text encoding processing on the concatenated sample text via the text encoder comprises:
performing character encoding processing on each character in the concatenated sample text to obtain a character vector sequence;
performing character position encoding processing or paragraph position encoding processing on each character in the concatenated sample text to obtain a position vector sequence;
concatenating character vectors in the character vector sequence and position vectors in the position vector sequence in a character-wise concatenation manner to obtain the text representation vector sequence outputted by the text encoder.

8. The method of claim 6, wherein the autoregressive semantic feature extractor comprises a sample context encoder, a style gating control attention module, and a semantic output projection head module that are sequentially connected; and wherein performing the semantic feature extraction on the input style representation vector, the timbre representation vector, and the text representation vector sequence via the autoregressive semantic feature extractor to obtain the intermediate semantic feature vector sequence comprises:
for each current character to be predicted in the concatenated sample text, obtain a respective representation vector of a current character and the representation vectors of characters before the current character;
performing context feature extraction processing on the representation vector of the current character and the representation vectors of the characters via the sample context encoder to obtain a context representation vector corresponding to the current character; and
performing semantic feature extraction processing on the context representation vector, a style representation vector, and a timbre representation vector via the style gating control attention module and the semantic output projection head module, to obtain a semantic feature vector of the current character.

9. The method of claim 8, wherein the style gating control attention module is provided with a historical semantic memory encoder, an attention adjuster, and a style adjustment gate controller that are sequentially connected, and is configured to perform style trend extraction processing based on an existing semantic feature vector sequence outputted by the autoregressive semantic feature extractor, wherein the style trend extracted is used for predicting the semantic feature vector of the current character.

10. The method of claim 5, wherein adjusting the parameter of the semantic encoding network based on the predicted semantic feature vector sequence and the output semantic feature vector sequence to obtain the trained semantic encoding network comprises:
determining a value of a sub loss function in at least one dimension based on the predicted semantic feature vector sequence and the output semantic feature vector sequence, wherein the at least one dimension comprises a style dimension, a timbre dimension, a semantic dimension, or a style consistency dimension; and
adjusting the parameter of the semantic encoding network based on the value of the sub loss function in the at least one dimension, to obtain the trained semantic encoding network.

11. The method of claim 10, wherein the value of the sub loss function in the style dimension is determined based on a style representation vector outputted by the style encoder and a predicted style representation vector, wherein the predicted style representation vector is obtained by extracting a style of the predicted semantic feature vector sequence;
the value of the sub loss function in the timbre dimension is determined based on a timbre representation vector corresponding to the timbre sample speech and a predicted timbre representation vector, wherein the predicted timbre representation vector is obtained by extracting a timbre from the predicted semantic feature vector sequence;
the value of the sub loss function in the semantic dimension is determined based on the predicted semantic feature vector sequence and the output semantic feature vector sequence; and
the value of the sub loss function in the style consistency dimension is determined based on predicted semantic feature vectors corresponding to adjacent characters in the predicted semantic feature vector sequence.

12. The method of claim 1, wherein training the semantic decoding network based on the style sample speech, the timbre sample speech, the input sample text, and the output sample speech comprises:
inputting the style sample speech, the timbre sample speech, and the input sample text into a trained semantic encoding network to obtain a predicted semantic feature vector sequence outputted by the trained semantic encoding network;
inputting the predicted semantic feature vector sequence into the semantic decoding network, to obtaining an output prediction speech outputted by the semantic decoding network; and
adjusting a parameter of the semantic decoding network based on the output prediction speech and the output sample speech, to obtain a trained semantic decoding network.

13. The method of claim 12, wherein inputting the predicted semantic feature vector sequence into the semantic decoding network to obtain the output prediction speech outputted by the semantic decoding network comprises:
obtaining a style representation vector corresponding to the style sample speech;
inputting the style representation vector and the predicted semantic feature vector sequence into the semantic decoding network, to obtain the output prediction speech outputted by the semantic decoding network.

14. The method of claim 12, wherein adjusting the parameter of the semantic decoding network based on the output prediction speech and the output sample speech to obtain the trained semantic decoding network comprises:
determining a value of a sub loss function in at least one dimension based on the output prediction speech and the output sample speech, wherein the at least one dimension comprises a speech dimension, a speech prosody dimension, or a speech consistency dimension; and
adjusting the parameter of the semantic decoding network based on the value of the sub loss function in the at least one dimension to obtain the trained semantic decoding network.

15. The method of claim 14, wherein the value of the sub loss function in the speech dimension is determined based on a speech similarity between the output prediction speech and the output sample speech;
the value of the sub loss function in the speech prosody dimension is determined based on predicted prosody data and sample prosody data, wherein the predicted prosodic data is obtained by extracting prosody from the output prediction speech, and the sample prosody data is obtained by extracting prosody from the output sample speech; and
the value of the sub loss function in the speech consistency dimension is determined based on a difference between adjacent speech frames in the output prediction speech.

16. A speech synthesis method, comprising:
obtaining a style speech, a timbre speech, and an input text to be processed;
obtaining a speech synthesis model, wherein a semantic encoding network and a semantic decoding network in the speech synthesis model are trained respectively based on a style sample speech, a timbre sample speech, an input sample text, and an output sample speech;
inputting the style speech, the timbre speech, and the input text into the semantic encoding network of the speech synthesis model, to obtain a semantic feature vector sequence outputted by the semantic encoding network; and
inputting the semantic feature vector sequence into the semantic decoding network, to obtain an output speech corresponding to the input text outputted by the semantic decoding network.

17. An electronic device comprising:
at least one processor; and
a memory, connected in communication with at least one processor;
wherein the at least one processor is configured to:
obtain training data, wherein training samples in the training data comprise a style sample speech, a timbre sample speech, an input sample text, and an output sample speech;
obtain an initial speech synthesis model, wherein the initial speech synthesis model comprises a semantic encoding network and a semantic decoding network;
train the semantic encoding network and the semantic decoding network respectively based on the style sample speech, the timbre sample speech, the input sample text, and the output sample speech, to obtain a trained semantic encoding network and a trained semantic decoding network; and
obtain a trained speech synthesis model based on the trained semantic encoding network and the trained semantic decoding network.

18. An electronic device comprising:
at least one processor; and
a memory, connected in communication with at least one processor;
wherein the at least one processor is configured to perform the method of claim 16.

19. A non-transitory computer-readable storage medium, having computer instructions stored thereon, wherein the computer instructions are configured to cause a computer to perform the method claim 1.

20. A non-transitory computer-readable storage medium, having computer instructions stored thereon, wherein the computer instructions are configured to cause a computer to perform the method claim 16.
